(19) United States
(12) Patent Application Publication
(10) Pub. No.: US 2005/0104823 A1
(43) Pub. Date: May 19, 2005

(54) Two sided display device

(76) Inventors: Andrea Giraldo, Eindhoven (NL); Mark Thomas Johnson, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/507,191

(22) PCT Filed: Feb. 12, 2003
(86) PCT No.: PCT/IB03/00580

(30) Foreign Application Priority Data
Mar. 13, 2002 (EP) 02075986.6

(51) Int. Cl. G09G 3/36

(52) U.S. Cl. 345/87

(57) ABSTRACT

Driving of a two-sided viewable display (a display that provides information on both sides) is performed by means of mirroring switching circuits Techniques for simultaneous (total or partial) view are also proposed.

The invention relates to a display device viewable from two opposite sides, the display device comprising at least a first substrate being provided with electrodes for defining picture elements, the device further comprising driving selection means for selecting rows of picture elements in a first mode of driving, the display being viewed from a first direction substantially perpendicular to the substrate said first mode of driving and driving means for selecting rows of picture elements in a second mode of driving the display being viewed from a second direction opposite to said first direction in said second mode of driving.

Examples of such active matrix display devices are TFT-LCDs or AM-LCDs, which are used in laptop computers and in organizers, but also find an increasingly wider application in GSM telephones. Instead of LCDs, for example, (organic). LED display devices may also be used or displays based on other effect such as electrophoresis, mirror displays etc.

Electronic equipment in which data can be made visible from opposite sides finds increasingly growing acceptance in for instance laptop computers and organizers, but also in cash registers.

In the equipment used so far generally two display screens are used, one for each viewing direction, which is rather costly. If a single display layer (electro-optical layer provided with driving electrodes) is realized such a display (a display that shows (video) information on both sides) always requires mirrored data to be readable on one of the sides the so-called mirroring or inversion problem. The inversion function can be implemented in the display controller where data processing replaces pixel data with mirrored (inverted) pixel data. This requires extra electronics (ICs or functional arts of ICs) with this special function and in particular it costs more operations and therefore more power.

It is one of the objectives of the present invention to provide a solution to this problem.

To this end a display device according to the invention device further comprises means for providing data and driving means for mirroring with respect to a mirroring line of a display section the data for the contents of picture elements to be written.

Since the inversion function is now implemented in the display device, no special drivers are needed. The mirroring line may substantially coincide with a column or a line of picture elements or be situated between two columns or two lines of picture elements.

In a preferred embodiment the driving means for mirroring a display section, having k columns, comprise means for interchanging the contents of picture elements (i, j) and the contents of picture elements (i, k−j), i being a row number of the display driving the display section. This represents mirroring with respect to a column direction. In a similar way mirroring with respect to a row direction is possible.

These and other aspects of the invention will be apparent from and elucidated with reference to the embodiments described hereinafter.

In the drawings:

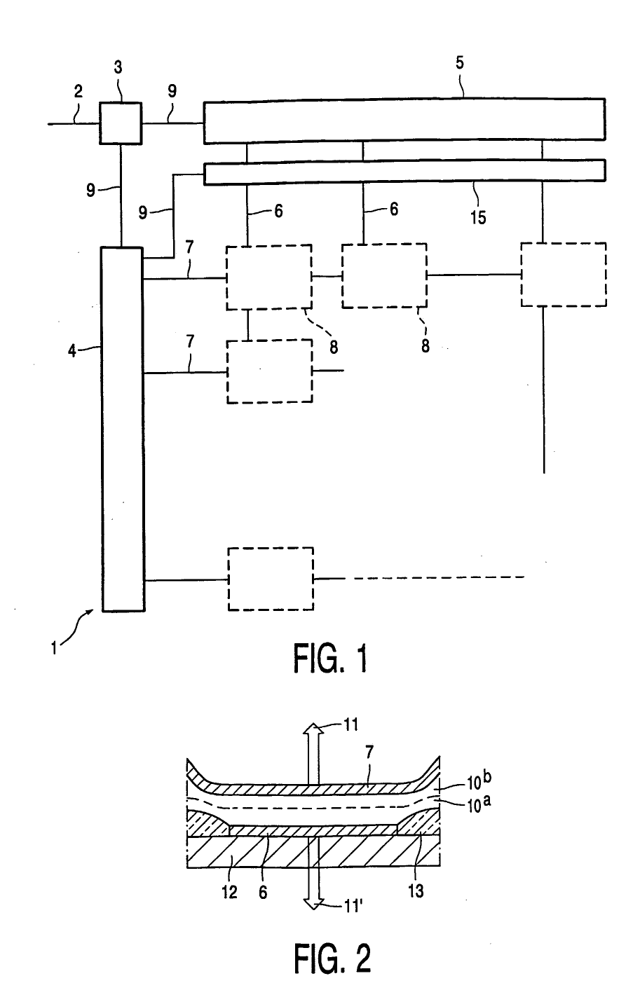

FIG. 1 is an electric circuit diagram of the display device, FIG. 2 is a diagrammatic cross-section of a part of a display device to explain the invention,

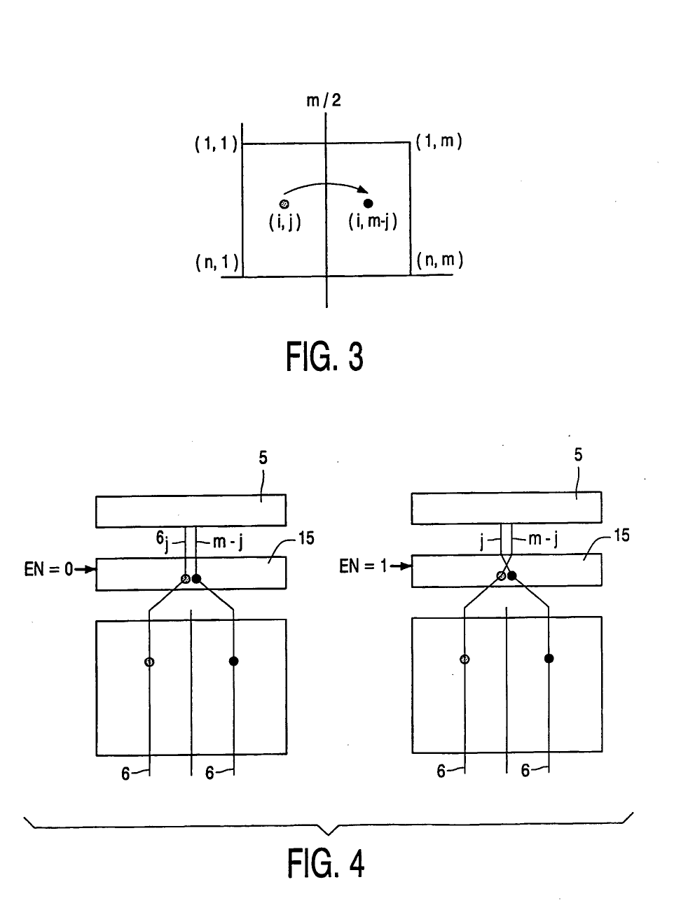

FIGS. 3 and 4 show the mirroring transformation,

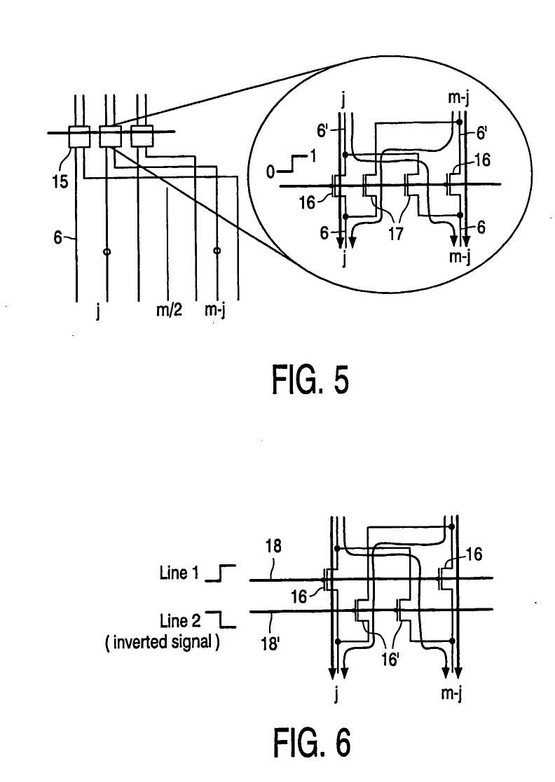

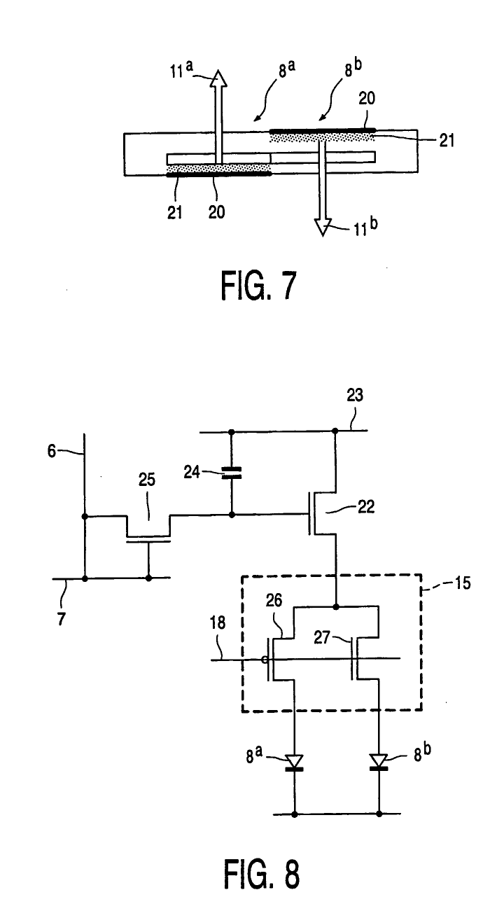

FIGS. 5 and 6 show embodiments of a part of the device enabling the mirroring transformation while FIG. 7 is a diagrammatic cross-section of a part of a display device to explain the invention and

FIG. 8 shows a part of a device enabling the mirroring transformation.

The Figures are diagrammatic and not drawn to scale. Corresponding elements are generally denoted by the same reference numerals.

FIG. 1 is an electric equivalent circuit diagram of a part of a display device 1 to which the invention is applicable. It comprises a matrix of pixels 8 defined by the areas of crossings of row or selection electrodes 7 and column or data electrodes 6. The row electrodes are consecutively selected by means of a row driver 4, while the column electrodes are provided with data via a data register 5. To this end, incoming data 2 are first processed, if necessary, in a processor 3. Mutual synchronization between the row driver 4 and the data register 5 takes place via drive lines 9.

FIG. 2 shows a diagrammatic cross-section of a light emitting pixel 8 on a glass substrate 12. A light emitting layer 10 is provided between transparent row or selection electrodes 7 and transparent column or data electrodes 6. The transparent electrodes in this example are ITO-electrodes. The light-emitting layer 10 in this example comprises sub-layers 10a, 10b of e.g. poly (p-phenylene vinylene) or PPV and polyethylenedioxythiophene (PEDOT). To prevent inter-pixel leakage the electrodes are mutually separated by insulating layers 13. The use of transparent cathodes and anodes allows emission 111 on one side from the luminescent layer through the transparent cathode 7 and emission 11′ on the other side from the luminescent layer through the transparent anode 6 (usually ITO) and the substrate 12 (e.g. glass).

In this example contrast, on both sides will be bad due to the fact that the display itself appears fully or partially transparent. Solutions to this problem are not described in detail here since, as mentioned above, this application mainly deals with a driving problem in the two-sided display, namely that the video information is correct on one side and mirrored in the other.

The image written in the display as perceived by the “back” viewer is different from the one as perceived by the “front” viewer, as a result of the mirroring transformation defined in FIG. 3. Mathematically it is a parity with axis coincident with the vertical middle line. All pixels with column index m/2 are not mirrored while the ones on the left are transformed to the ones on the same row but on the right at equal distance from the middle line and vice versa.

When the inverse of this function is applied to the image in the display the back view is no longer mirrored and therefore it is correct. This function is also called “inversion”. The inversion function can be implemented in the display controller where data processing replace pixels (i,j) with pixels (i,m−j). But it requires a chip with this special function and in particular it uses more operations and therefore more power.

According to the invention integration of the inversion function is realized in the display. To this end the display device (the column driver 5) comprises a switch section 15 (FIGS. 1,4) which enables “normal view” (EN=0) and “inverted view” (EN=1). Different ways of realization are possible for the switch. Enabling can also be initiated via connections to sensors that establish which is the preferred view, for example by means of a photodiode or pressure sensor, which determines whether a (mobile phone) display is opened or closed.

### Embodiment 1

FIG. 5 shows a first embodiment of the inversion function, which may be integrated in the driving circuit or on the display substrate by means of active matrix technologies (for example polycrystalline silicon technology). The switching units (on one side on top of the columns) comprise four MOS-transistors per pair of columns. PMOS-transistors (switches) 16 interconnect outputs (j) 6′ of the column driver 5 to corresponding columns 6 (j). NMOS-transistors (switches) 17 interconnect outputs lines (j) 6′ of the column driver 5 to corresponding mirrored column output lines 6 (m−j). With EN=0 the PMOS transistors are open (and the NMOS transistors are closed) and outputs 6′,j and 6′,m−j respectively, of the column driver 5 correspond to columns 6, j and 6,m−j respectively. With EN=1 the NMOS-transistors (switches) 17 are open (and the PMOS-transistors are closed) and outputs 6′,j and 6′,m−j correspond to columns 6, m−j and 6,j respectively.

### Embodiment 2

FIG. 6 shows a second embodiment of the inversion function, using transistors of the same type. The switching units (on one side on top of the columns) comprise four PMOS-transistors per pair of columns and two enabling lines 18, 18′. With line 18 high (Line1) and line 18′ low (Line 2) the PMOS transistors 16 are open (and the PMOS transistors 16′ are closed) and outputs 6′,j and m−j respectively, of the column driver 5 correspond to columns 6, j and m−j respectively. With line 18′ high (Line2) and line 18 low (Line 1) the PMOS-transistors 16′ are open (and the PMOS-transistors 16 are closed) and outputs 6′,j and m−j correspond to columns 6, m−j and j respectively. An equivalent circuit may be realized with NMOS-transistors, which may be realized in amorphous crystalline silicon technology.

### Embodiment 3

In FIG. 7 simultaneous front and back view is realized by making two sub-pixels out of one pixel. One sub-pixel 8a emits light 11a to the front and the other sub-pixel 8b emits light 11b to the back. The sub-pixels are operated synchronously with the Enabling Inversion function described above, by means of two additional switches (for example a NMOS transistor 26 and a PMOS transistor 27). Current is provided from a voltage line 23 via transistor 22 which together with a capacitance 24 forms a current source. The current source is enabled by selection of a data voltage from data electrode 6, which is passed to the current source via switch (transistor) 25 by a selection electrode 7, enabling said switch (transistor) 25.

Adding a black matrix 20 and a mirror 21 prevents emission to the wrong side.

The protective scope of the invention is not limited to the embodiments described. Furthermore, although described in the embodiments with respect to LED's the invention is applicable to other display mechanisms like liquid crystal displays, electrochromic displays, electrophoretic displays and other display mechanisms, which allow two-sided viewing (both in passive and active addressing).

As shown in FIGS. 7,8 the two-sided display with inversion switching can also be used for simultaneous front and back view. In another display this is achieved by shutters, for instance by using shutter layers on top of each side, the shutter layers operating synchronously with the mirroring enabling function. Possible shutters could be made with TN-LC (twisted nematic LC), FLC (ferroelectric LC), PDLC (polymer dispersed LC) or a guest/host system with dyes (solution gels).

It is also possible to intentionally invert all or part of the screen (viewing pictures, special effects/split screen). As mentioned above the circuits described may be used also for enabling the mirroring with respect to a row direction.

Also in realizing the mirroring circuits a lot of other possibilities exist, like the use of other techniques, e.g. bipolar transistors.

The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

1. A display device viewable from two opposite sides, the display device comprising at least a first substrate being provided with electrodes for defining picture elements, the device further comprising driving selection means for selecting rows of picture elements in a first mode of driving, the display being viewed from a first direction substantially perpendicular to said first substrate in said first mode of driving and driving means for selecting rows of picture elements in a second mode of driving the display being viewed from a second direction opposite to said direction in said second mode of driving, said display device further comprising means for providing data and driving means for mirroring with respect to a mirroring line of a display section the data for the contents of picture elements to be written.

2. A display device according to claim 1 in which the mirroring line substantially coincides with a column or a line of picture elements.

3. A display device according to claim 1 in which the mirroring line is situated between two columns or two lines of picture elements.

4. A display device according to claim 2 in which the driving means for mirroring a display section having k columns comprise means for interchanging the contents of picture elements (i, j) and the contents of picture elements (i, k−j), i being a row number of the display section.

5. A display device according to claim 4 in which two of the k columns are provided with a first kind of switches between columns j of picture elements and the means for providing data to said columns j of picture elements and a second kind of switches between the columns (k−j) and said means for providing data to the columns j of picture elements.

6. A display device according to claim 5 in which the first and second kind of switches are complementary transistors and the driving means for mirroring comprise common enabling means for said complementary transistors.

7. A display device according to claim 5 in which the driving means for mirroring comprise complementary enabling means for said first and second kind of switches.

8. A display device according to claim 2 in which the driving means for mirroring a display section having k rows comprise means for interchanging the contents of picture elements (i, j) and the contents of picture elements (k−i, j), j being a column number of the display section.

9. A display device according to claim 8 in which two of the k rows are provided with a first kind of switches between rows j of picture elements and the means for selecting said rows j of picture elements and a second kind of switches between the rows (k−j) and said means for selecting the rows j of picture elements.

10. A display device according to claim 9 in which the first and second kind of switches are complementary transistors and the driving means for mirroring comprise common enabling means for said complementary transistors.

11. A display device according to claim 9 in which the driving means for mirroring comprise complementary enabling means for said first and second kind of switches.

12. A display device according to claim 1 in which the picture element are divided in sub-pixels and the driving means for mirroring mirror one kind of sub-pixels.

13. A display device according to claim 12 in which said first and second mode of driving are performed substantially simultaneously

14. A display device according to claim 12 in which, viewed in a direction substantially normal to the display, different sub-pixels at different sides of the display comprise an absorbing or a reflecting layer.

15. A display device according to claim 1 in which the picture elements comprise electroluminescent diodes.
